(19) United States
(12) Patent Application Publication
(10) Pub. No.: US 2002/0033911 A1
(43) Pub. Date: Mar. 21, 2002

(54) Liquid crystal display apparatus and manufacturing method therefor

(76) Inventors: Nobuhisa Ishida, Kyoto-Shi (JP); Kouichi Sameshima, Akashi-Shi (JP); Norihiro Agawa, Itami-Shi (JP); Takamitsu Kakinaga, Kyoto-Shi (JP)

Correspondence Address: SIDLEY AUSTIN BROWN & WOOD, 717 NORTH HARWOOD, SUITE 3400, DALLAS, TX, 75201, US

(21) Appl. No.: 09/938,177

(22) Filed: Aug. 23, 2001

(30) Foreign Application Priority Data
Aug. 28, 2000 (JP) 2000-258065

(51) Int. Cl. G02F 1/1343; G02F 1/1347

(52) U.S. Cl. 349/74; 349/143

(57) ABSTRACT

Disclosed is a liquid crystal display apparatus comprising: a first liquid crystal display panel having a plurality of first scanning electrodes and a plurality of first signal electrodes; and a second display panel having a plurality of second scanning electrodes and a plurality of second signal electrodes, wherein the first display panel is stacked on the second display panel such that (i) terminals of the first scanning electrodes oppose to terminal of the second scanning electrodes, and (ii) terminals of the first scanning electrodes are electrically connected to terminals of the second scanning electrodes, respectively, so that the first and second scanning electrodes are connected to a common scanning drive circuit.

### CROSS REFERENCE TO RELATED APPLICATION

This application is based on Japanese Patent Application No. 2000-258065 filed in Japan on Aug. 28, 2000, the entire content of which is hereby incorporated by reference.

### BACKGROUND OF THE INVENTION

1. Field of the Invention

The present invention relates to a display apparatus and to a manufacturing method therefor, and more particularly to a display apparatus that comprises multiple display panels stacked together, each of which comprises liquid crystal, etc., and that drives each pixel via matrix driving, as well as to a manufacturing method therefor.

2. Description of the Related Art

Various liquid crystal display apparatuses that display digitized letter and image information as visible information have been researched and developed in recent years. In particular, there is strong demand for portable display terminals that are compact and thin and consume little power. There is also demand for high-quality multi-color reproducibility of images.

As such a display apparatus, a reflective liquid crystal display apparatus employing the selective reflection of cholesteric liquid crystal or chiral nematic liquid crystal is known, for example. Using a liquid crystal display apparatus of this type, a multi-color display may be obtained through the stacked three liquid crystal display panels, i.e., liquid crystal display panels for red display, green display and blue display, respectively

Compactness and thinness are also demanded in such a liquid crystal display apparatus that includes a multi-layer liquid crystal display element comprising multiple display panels. However, in a liquid crystal display apparatus including a conventional multi-layer liquid crystal display element, the number of drive circuit components such as drive ICs essentially increases in order to drive each liquid crystal display panel, making the apparatus insufficiently compact and thin.

In addition, where multiple liquid crystal display panels are stacked to form this type of liquid crystal display apparatus, the electrode connections between each panel are complex, and a more efficient manufacturing method is desired.

### SUMMARY OF THE INVENTION

An object of the present invention is therefore to provide an improved multi-layer display apparatus and a manufacturing method therefor.

Another object of the present invention is to provide a display apparatus in which the electrodes of the stacked multiple display panels may be connected to a common drive source in an easy and reliable fashion, as well as a manufacturing method therefor.

In order to attain these objects, the display apparatus pertaining to the present invention comprises: a first display panel having a plurality of first scanning electrodes and a plurality of first signal electrodes; and a second display panel having a plurality of second scanning electrodes and a plurality of second signal electrodes, wherein the first display panel is stacked on the second display panel such that (i) terminals of the first scanning electrodes oppose to terminal of the second scanning electrodes, and (ii) terminals of the first scanning electrodes are electrically connected to terminals of the second scanning electrodes, respectively.

In the display apparatus pertaining to the present invention and having the above construction, since the first scanning electrodes and the second scanning electrodes are electrically connected, respectively, these scanning electrodes can be connected to a common drive source in an easy and reliable fashion via direct connection or via a conductive material in between. Consequently, the scanning can be driven by a single common scanning electrode drive circuit.

Furthermore, in the display apparatus pertaining to the present invention, the terminals of the first and second scanning electrodes may be electrically connected while in pressure contact with each other via a pressing member, or may be electrically connected via a wiring material having an exposed conductive material on either side thereof In the former case, the conductive material by which to connect the scanning electrodes is not needed. In the latter case, the reliability of the connection of the scanning electrodes increases.

Moreover, a third display panel that has a plurality of third scanning electrodes and a plurality of third signal electrodes may be additionally provided to the display apparatus. The third display panel may be disposed between the first and second display panels, while may be provided so that the first, second, and third display panel is stacked in this order. In any cases, the connection between the first panel and the third panel may be achieved via the end of the first panel opposite the other end at which the first panel and the second panel are connected. In this case, because the terminals of each panel are not exposed to excessive conditions that may occur for connection purposes, the occurrence of connection failure may be reduced. Furthermore, the third scanning electrodes and the wiring of the circuit substrate may be electrically connected at the end of the above wiring member.

The substrates of the display panel on which the scanning and signal electrodes are respectively formed may be made of a hard material or a soft material. If a pliable substrate, particularly a resin film, is used, handling of the substrate during manufacturing is easy, and the method in which the first electrodes are electrically connected via pressure contact exerted by a pressing member may be easily adopted.

In any event, by connecting signal electrode drive circuits to the first, second, and third signal electrodes of the display panels, for example, each display panel can be individually driven based on separate image data.

The first manufacturing method pertaining to the present invention comprises the steps of (a) stacking multiple display panels, each of which has first and second electrodes, such that terminals of the first electrodes of at least two display panels oppose each other; and (b) electrically connecting the terminals of the opposing first electrodes after the step (a).

In the first manufacturing method comprising the above steps, the panels are stacked together such that the terminals of the first electrodes of at least two display panels oppose each other, enabling the first electrodes to be electrically connected to a common drive source in an easy and reliable fashion.

The step (b) may be carried out either by placing the terminals in direct pressure contact with each other or by using a conductive material therebetween. In the former case, because heating is not needed, connection failure caused by deformation of the substrates due to heating does not occur. In the latter case, connection may be achieved more easily and reliably

The second manufacturing method pertaining to the present invention furthermore has the following steps (a) through (d): (a) forming a plurality of first display panels that are connected each other by carrying out the sub steps (a-1) and (a-2): (a-1) disposing a first liquid crystal material a first substrate on which a plurality of first scanning electrodes are formed and a second substrate on which a plurality of first signal electrodes, which extend in a different direction from the first scanning electrodes, are formed; and (a-2) dividing the second substrate into a plurality of sections along the first scanning electrodes; (b) forming a plurality of second display panels that are connected each other by carrying out the sub steps (b-1) through (b-3): (b-1) disposing a second liquid crystal material between a third substrate on which a plurality of second scanning electrodes are formed and a fourth substrate on which a plurality of second signal electrodes, which extend in a different direction from the second scanning electrodes, are formed; (b-2) dividing the second substrate into a plurality of sections along the second scanning electrodes; and (b-3) forming openings on the third substrate such that tongue-like terminals of the second scanning electrodes are formed; (c) stacking the second display panels on the first display panels such that the first scanning electrodes oppose to the second scanning electrodes; and (d) connecting the tongue-like terminals of the second scanning electrodes to the first scanning electrodes.

In the second manufacturing method comprising the above steps, at least the first and second display panels are manufactured in units of display sections, and are stacked together such that the tongue-shaped terminals of the second scanning electrodes of the second display panels oppose the first scanning electrodes of the first display panels, enabling a display apparatus having a stacked configuration to be easily manufactured.

In addition, because multiple multi-layer display panels may be manufactured at the same time, display apparatuses may be efficiently manufactured.

In the second manufacturing method, the following steps (e) and (f) may further be added: (e) forming a third display panels that are connected each other by carrying out the sub steps (e-1) through (e-3): (e-1) disposing a third liquid crystal material between a fifth substrate on which a plurality of third scanning electrodes are formed and a sixth substrate on which a plurality of third signal electrodes, which extend in a different direction from the third scanning electrodes, are formed; (e-2) dividing the sixth substrate into a plurality of sections along the second electrodes; (e-3) forming openings on the fifth substrate such that tongue-like terminals are formed; and (f) stacking the third display panels on the second display panels such that the first scanning electrodes and the third scanning first electrodes oppose each other.

By adding the above steps (e) and (f), a three-layer multi-layer liquid crystal display apparatus in which the first electrodes are connected to a common drive source may be easily manufactured.

In the second manufacturing method, one multi-layer liquid crystal display panel may be obtained by separating the stacked display panels by cutting the first and second substrates between the sections.

In addition, in both the first and second manufacturing methods, a common first drive circuit may be connected to each display panel, and therefore the drive circuit may be easily connected. Furthermore, resin film may be used for the first and second substrates. Where a resin film is used, handling during manufacturing is easy. Electrical connection of the first electrodes via direct pressure contact is particularly easy in this case.

### BRIEF DESCRIPTION OF THE DRAWINGS

These and other objects, advantages and features of the invention will become apparent from the following description thereof taken in conjunction with the accompanying drawings in which:

FIG. 1 is a cross-sectional view showing the basic construction of a multi-layer liquid crystal display element;

FIG. 2 is a cross-sectional view showing the important components of the first embodiment of the liquid crystal display apparatus pertaining to the present invention;

FIG. 3 is a perspective view showing the flexible print circuit used in the first embodiment;

FIG. 4 is a cross-sectional view showing the important components of the second embodiment of the liquid crystal display apparatus pertaining to the present invention;

FIG. 5 is a drawing showing in summary fashion the third embodiment of the liquid crystal display apparatus pertaining to the present invention;

FIG. 6 is a drawing showing the pressure contact regarding the scanning electrodes in the third embodiment;

FIG. 7 is a drawing showing in summary fashion the fourth embodiment of the liquid crystal display apparatus pertaining to the present invention;

Parts (A) and (B) of FIG. 8 are a plan view and a cross-sectional view, respectively, of the fifth embodiment of the liquid crystal display apparatus pertaining to the present invention;

FIG. 9 is a cross-sectional view showing the sixth embodiment of the liquid crystal display apparatus pertaining to the present invention;

Parts (A) through (D) of FIG. 10 are drawings showing the manufacturing of the liquid crystal display panel R in the manufacturing process for the fifth and sixth embodiments;

Parts (A) through (D) of FIG. 11 are drawings showing the manufacturing of the liquid crystal display panel G in the manufacturing process for the fifth and sixth embodiments;

Parts (A) through (D) of FIG. 12 are drawings showing the manufacturing of the liquid crystal display panel B in the manufacturing process for the fifth and sixth embodiments;

Parts (A) and (B) of FIG. 13 are a plan view and a side elevation, respectively, showing the liquid crystal display panels R, G and B stacked together in the manufacturing process for the fifth and sixth embodiments; and

Parts (A) and (B) of FIG. 14 are a plan view and a side elevation, respectively, showing one unit of liquid crystal display apparatus that is separated in the manufacturing process for the fifth and sixth embodiments.

### DESCRIPTION OF THE PREFERRED EMBODIMENTS

The display apparatus pertaining to embodiments of the present invention and the manufacturing method therefor are explained below with reference to the accompanying drawings.

A reflective liquid crystal display apparatus using cholesteric liquid crystal will be used in the explanation below as an example of a display apparatus using simple matrix driving.

(Basic Construction of Liquid Crystal Display Element)

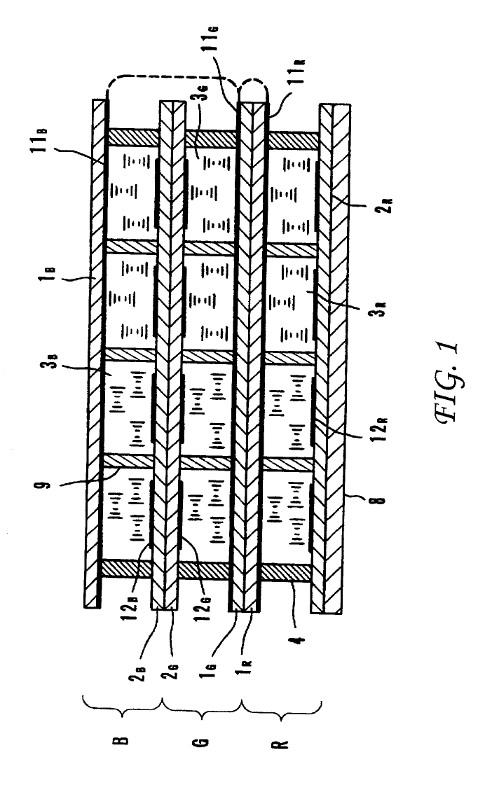

FIG. 1 shows the basic construction of the multi-layer display element used in the liquid crystal display apparatus of this embodiment. This multi-layer display element comprises a red display panel R that performs display by alternating between selective reflection of red and a transparent state and that is placed on the light absorbing layer 8, a green display panel G that performs display by alternating between selective reflection of green and a transparent state and that is placed on the red display panel R, and a blue display panel B that performs display by alternating between selective reflection of blue and a transparent state and that is placed on the green display panel G

Each display panel R, G and B comprises transparent substrates 1 and 2, on which transparent electrodes 11 and 12 are formed, respectively, and liquid crystal 3, which is held between the two substrates. The display panel R holds cholesteric liquid crystal 3_{R} for red display, the display panel G holds cholesteric liquid crystal 3_{G} for green display, and the display panel B holds cholesteric liquid crystal 3_{B} for blue display The electrodes 11 and 12 and substrates 1 and 2 also have the subscript R, G or B depending on which of the display panels R, G and B to which they belong.

Sealing walls 4 that contain the liquid crystal 3 are formed between the substrates 1 and 2. In addition, although omitted from the drawing, spacers are also held between the substrates 1 and 2 in order to maintain the distance therebetween.

For the substrates 1 and 2, hard substrates such as glass, or flexible substrates such as transparent resin films, may be used. Materials for transparent resin films include polyarylate resin, polyether sulfone resin, polycarbonate resin, norbornen resin, amorphous polyolefine resin and denatured acrylate resin.

9 indicates a resin body that is formed if necessary. These resin bodies adhere to the top and bottom substrates 1 and 2 and prevent the distance between the substrates 1 and 2 from widening. In addition, thin films such as an orientation control film or an insulation film may be formed on the surfaces of the substrates 1 and 2 on which the electrodes are formed.

The electrodes 11 and 12 formed on each display panel R, G and B comprise multiple belt-shaped electrodes that are aligned parallel to each other at prescribed intervals, and the electrodes 11 and electrodes 12 oppose each other such that directions in which they extend are perpendicular to each other. Display is performed through the impression of a voltage to the liquid crystal via these top and bottom belt-shaped electrodes.

In the multi-layer liquid crystal display element shown in FIG. 1, the electrodes 12 comprise signal electrodes, while the electrodes 11 comprise scanning electrodes. When a signal voltage corresponding to the image data to display is impressed to each signal electrode while a selection voltage is impressed to prescribed scanning electrodes, display is performed with regard to the pixels aligned on the scanning electrodes. Display is carried out through the impression of a voltage to each signal electrode while a selection voltage is sequentially impressed to each scanning electrode (matrix driving).

The liquid crystal 3 contained in each liquid crystal display panel R, G and B comprises liquid crystal that exhibits a cholesteric phase at room temperature, or chiral nematic liquid crystal comprising nematic liquid crystal to which a chiral dopant is added such that the liquid crystal exhibits a cholesteric phase at room temperature, and in response to the voltage impressed between the top and bottom electrodes 11 and 12, alternates from a transparent state (focal conic state) in which visible light is allowed to pass through to a selective reflection state (planar state) in which visible light of a particular wavelength is selectively reflected, or vice versa.

For example, red display may be performed by turning the display panels B and G to a transparent state and the display panel R to a selective reflection state. Yellow display may be performed by turning the display panel B to a transparent state and the display panels B and R to a selective reflection state. Similarly, red, green, blue, white, cyan, magenta, yellow or black display is possible by appropriately turning each display panel R, G and B to a transparent state or a selective reflection state. Furthermore, an intermediate color may be displayed by selecting a state in which molecules in the focal conic state and molecules in the planar state coexist for each display panel R, G and B. Consequently, multi-color display may be enabled.

Incidentally, where the display panels R, G and B can be driven using identical or similar voltage levels, either the signal electrodes or the scanning electrodes may be connected to a common drive source. Therefore, in this multi-layer display element, the scanning electrodes 11 of each display panel are electrically connected with each other and may be connected to a common drive source (see the dotted lines in FIG. 1). Consequently, as explained below, the scanning electrodes 11_{R}, 11_{G} and 11_{B} of the display panels R, G and B are connected to a single common scanning drive circuit.

In order to harmonize the drive voltage levels for each display panel R, G and B, the composition of the liquid crystal compound, the thickness of the liquid crystal layer, and the types and thicknesses of the thin films such as the insulation film and orientation control film should be adjusted for each layer.

The method of connection of the scanning electrodes 11 is not limited to that shown in FIG. 1, and various different methods may be used. The various connection methods for the scanning electrodes are specifically explained below.

In the first through sixth embodiments described below, identical members and components are assigned identical numbers, and explanations thereof will not be repeated.

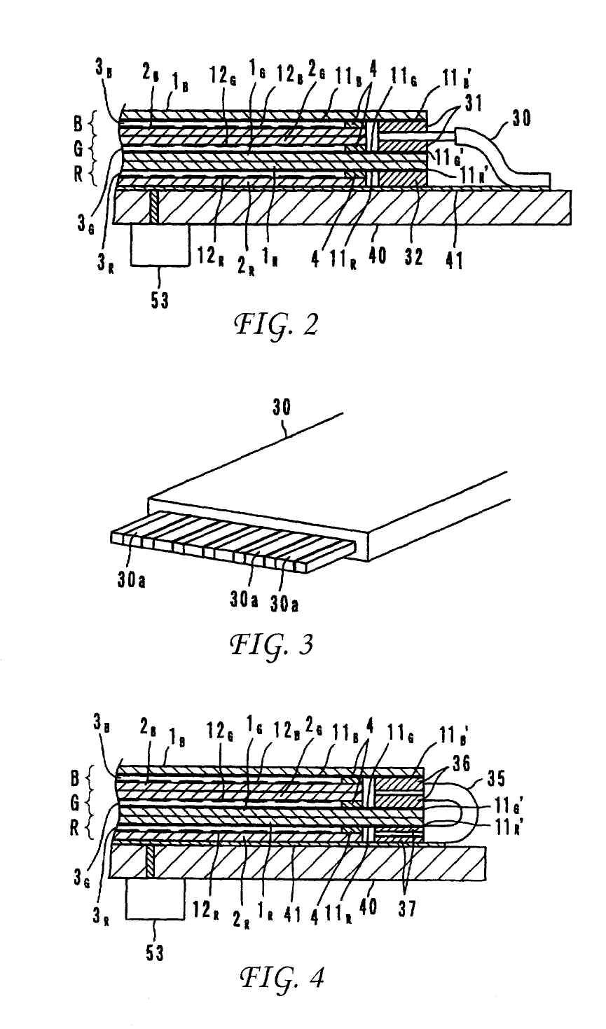

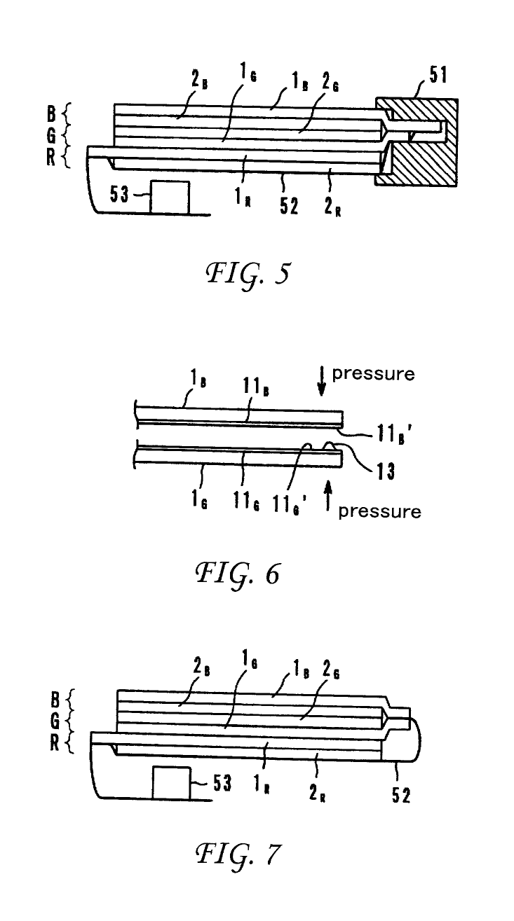

(First Embodiment, See FIGS. 2 and 3)

For the liquid crystal display apparatus comprising the first embodiment of the present invention, an element is used that comprises a liquid crystal display panel B that displays blue, a liquid crystal display panel G that displays green and a liquid crystal display panel R that displays red, said layers being stacked together as in the element explained with reference to FIG. 1, and this multi-layer unit is placed on a circuit substrate 40 having wiring 41 comprising a copper paste applied to the substrate.

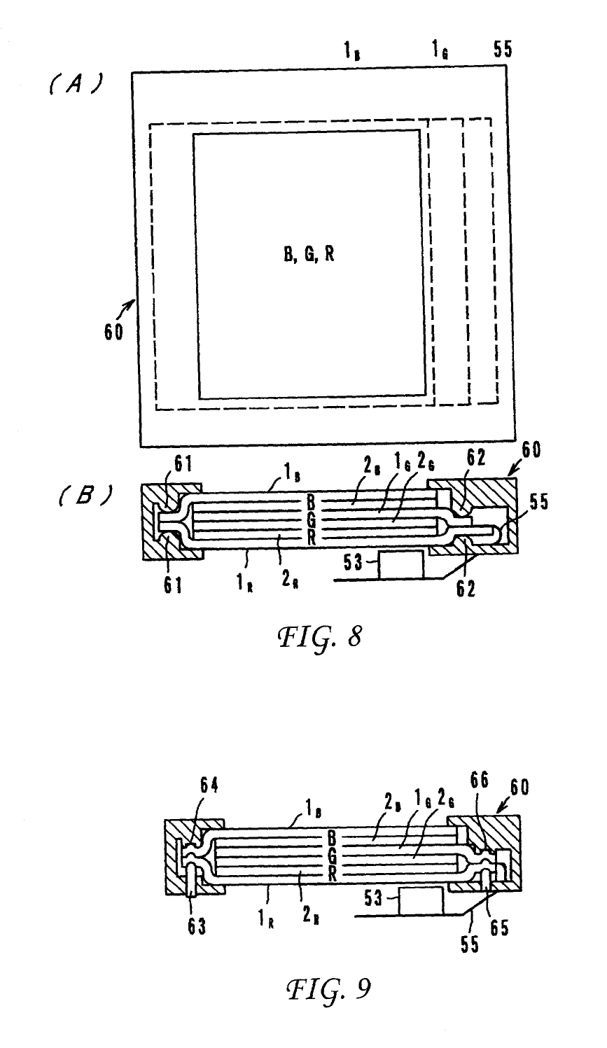

A light absorbing layer is placed on the back side of the liquid crystal display panel farthest from the observation side (the display panel R in the first embodiment), but is omitted from the drawing in FIG. 2 (as well as in FIG. 4 and onward).

In the first embodiment, each substrate comprises a transparent hard material (such as glass) or a transparent flexible material (such as resin film). Multiple scanning electrodes and multiple signal electrodes are respectively formed on one surface of each substrate of each liquid crystal display panel using a transparent electrode material such as ITO or NESA film, which is first formed as thin film on the surface using a method such as sputtering or vacuum deposition. The film is then etched such that the electrodes are formed parallel to each other and at prescribed intervals. The substrates are then placed together such that the scanning electrodes and the signal electrodes are perpendicular to each other.

The construction and method of the connection that connects the scanning electrodes to a common drive source will now be explained. The panels are arranged such that terminals 11_{B}′ and 11_{G}′ of the scanning electrodes 11_{B} and 11_{G} oppose each other, and are electrically connected by placing a flexible print circuit 30 therebetween. One end of the flexible print circuit 30 has wiring 30a exposed on either side, as shown in FIG. 3. An anisotropic conductive film 31 is located on each surface of the exposed area of the wiring 30a, and the scanning electrodes 11_{B} and 11_{G} are electrically connected via the anisotropic conductive films 31.

The terminals 11_{R}′ of the scanning electrodes 11_{R} of the other panel are electrically connected to the wiring 41 on the circuit substrate 40 via the anisotropic conductive film 32. Furthermore, the other end of the flexible print circuit 30 is also electrically connected to the wiring 41, whereby the scanning electrodes 11_{B}, 11_{G} and 11_{R} of the liquid crystal display panels B, G and R are connected to a common drive source.

A single scanning drive circuit 53 is connected to the wiring 41. Signal drive circuits, which are not shown in the drawings, are respectively connected to the signal electrodes 12_{B}, 12_{G} and 12_{R} of each liquid crystal display panel B, G and R.

Because the number of flexible print circuits used may be reduced in the first embodiment, it offers the advantage of reduced cost.

It is also acceptable if a high-density signal drive circuit is used such that the signal drive circuits for the liquid crystal display panels R, G and B are integrated in one area. For example, a signal drive circuit that is divided into three different output terminals may be used, so that the signal electrodes of each display panel are connected to the corresponding output terminal of the signal drive circuit. Alternatively, the signal drive circuit may have only one output terminal, and in this case, monochrome display may be performed by connecting the signal electrodes of each display panel in a parallel fashion, and by simultaneously driving the multiple display panels (i.e., the three display panels R, G and B, for example) based on the same image data.

(Second Embodiment, See FIG. 4)

The liquid crystal display apparatus comprising the second embodiment has the same construction as the first embodiment in principle, and differs from the first embodiment only in regard to the electrical connections of the scanning electrodes 11_{B}, 11_{G} and 11_{R} of the liquid crystal display panels B, G and R. In this second embodiment, a flexible print circuit 35, the wiring of which is exposed at both ends and surfaces thereof, is used for electrical connection in place of the flexible print circuit 30 used in the first embodiment.

The terminals 11_{B}′ and 11_{G}′ of the scanning electrodes 11_{B} and 11_{G}, which are arranged such that they oppose each other, are electrically connected via the anisotropic conductive films 36 placed on each surface of the exposed wiring at one end of the flexible print circuit 35. The terminals 11_{R}′ of the other scanning electrodes 11_{R} are electrically connected to the wiring 41 on the circuit substrate 40 via the anisotropic conductive films 37 placed on each surface of the exposed wiring at the other end of the flexible print curcuit 35. Consequently, the scanning electrodes 11_{B}, 11_{G} and 11_{R} of the liquid crystal display panels B, G and R are connected to a common drive source.

Because the number of flexible print circuits used may be reduced in this second embodiment, the embodiment offers the advantage of reduced cost.

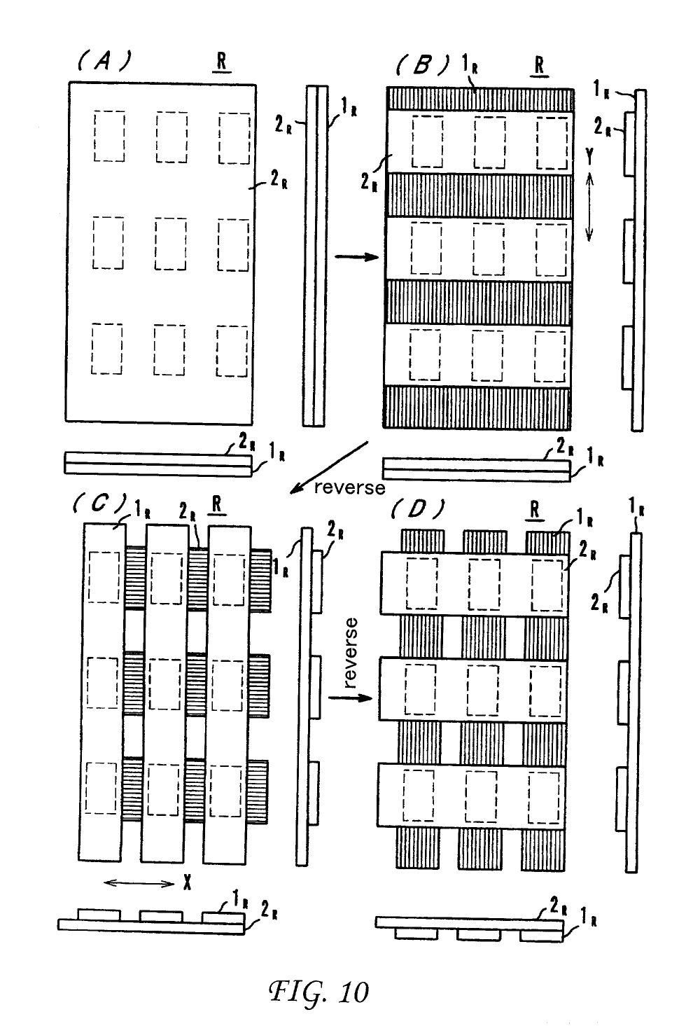

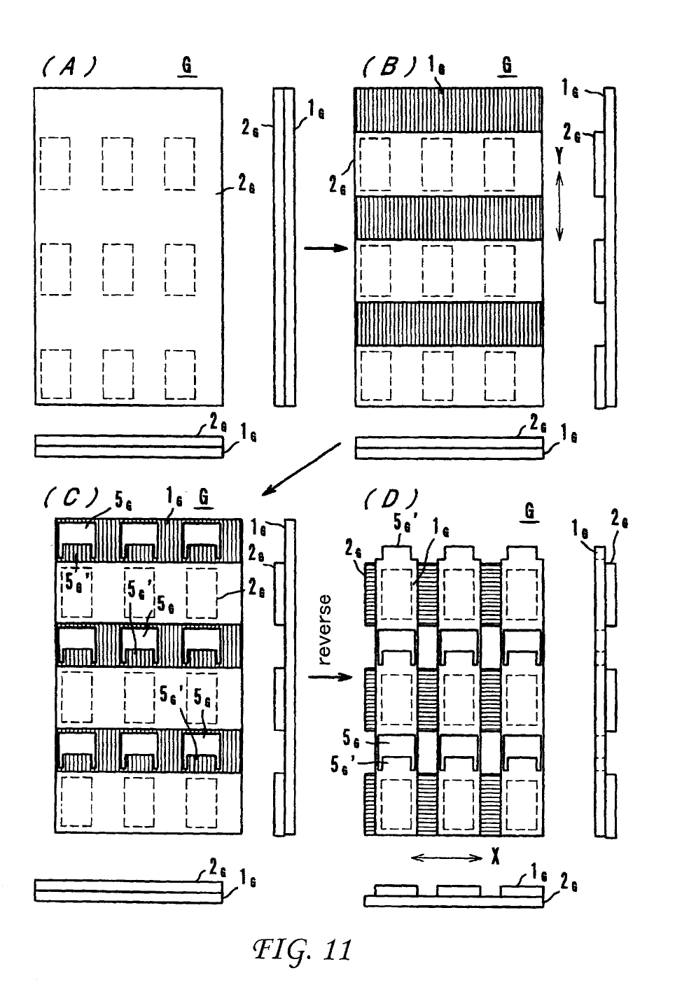

(Third Embodiment, See FIGS. 5 and 6)

The liquid crystal display apparatus comprising the third embodiment comprises an example in which the substrates of the liquid crystal display panels B, G and R consist of pliable resin film. In FIG. 5, the liquid crystal layers, scanning electrodes and signal electrodes are omitted from the drawing for purposes of simplification.

In this third embodiment, the terminals of the scanning electrodes, which are arranged such that they oppose each other, are electrically connected by the pressing member 51 that holds together the ends of the film substrates 1_{B} and 1_{G}. Furthermore, the flexible print circuit 52 extends along the film substrate 2_{R} while connected to the scanning electrodes on the film substrate 1_{B}, such that it is also electrically connected to the terminals of the scanning electrodes on the other film substrate 1_{R}.

Consequently, the scanning electrodes of the liquid crystal display panels B, G and R are connected to a common drive source. A single scanning drive circuit 53 is placed at the other end of the flexible print circuit 52 and drives each scanning electrode.

Because the scanning electrodes of a pair of display panels are pressed together to make them electrically connected, and the scanning drive circuit is connected via a single flexible print circuit in this third embodiment, the number of flexible print circuits used may be reduced. In addition, because the panels are connected at either side thereof, the terminals of each substrate are not exposed to excessive connecting conditions (such as pressure and temperature), enabling the prevention of connection failure due to pressure and heating used to connect the flexible print circuit.

Furthermore, as shown in FIG. 6, by placing a plating material 13 between the terminals 11_{B}′ and 11_{G}′ of the scanning electrodes 11_{B} and 11_{G} that are electrically connected via pressure contact, the electrical contact between the terminals may be ensured. The plating material used in this way in order to ensure electrical contact via pressure contact may also be applied in the fourth, fifth and sixth embodiments described below

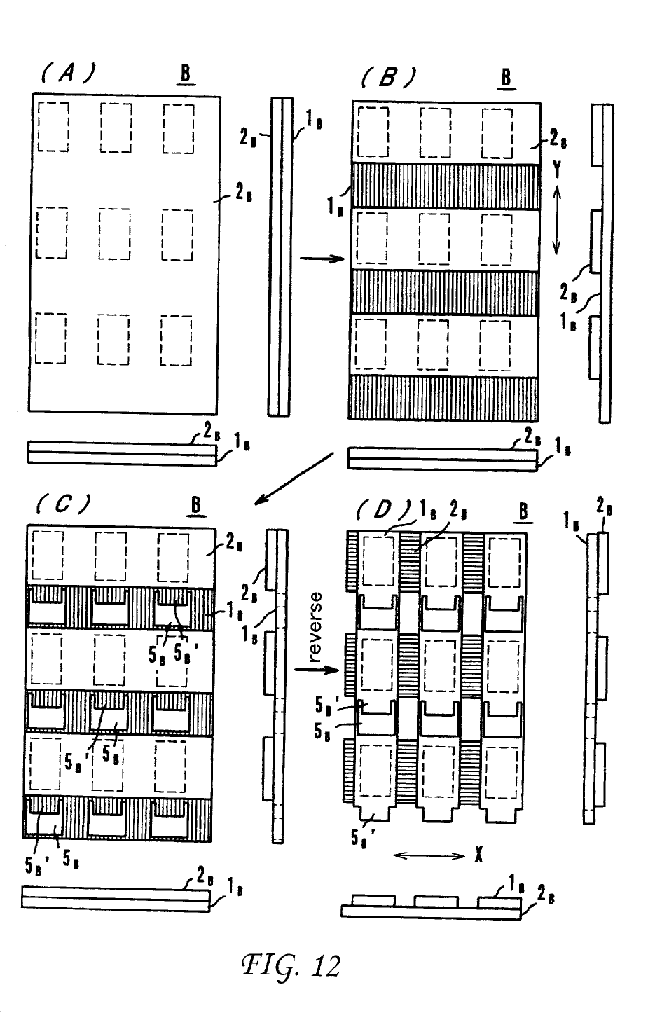

(Fourth Embodiment, See FIG. 7)

The liquid crystal display apparatus of the fourth embodiment also comprises a liquid crystal display element in which the substrates of the liquid crystal display panels B, G and R comprise pliable resin film, as in the case of the third embodiment described above.

The terminals of the scanning electrodes, which are arranged such that they oppose each other, are electrically connected because the ends thereof together hold one end of the flexible print circuit 52 via anisotropic conductive adhesive layers, using a pressure contact tool not shown in the drawing. Moreover, the flexible print circuit 52 extends along the film substrate 2_{R}, and is electrically connected to the terminals of the scanning electrodes of the other film substrate 1_{R}. Consequently, the scanning electrodes of the liquid crystal display panels B, G and R are connected to a common drive source.

Because the same effect as the third embodiment may be obtained and the pressure contact tool may be removed in this fourth embodiment, the frame of the liquid crystal display apparatus may be made small.

(Fifth Embodiment, See FIG. 8)

The liquid crystal display apparatus of the fifth embodiment also comprises a liquid crystal display element in which the substrates of the liquid crystal display panels comprise pliable resin film, as in the case of the third and fourth embodiments described above. The liquid crystal layers, scanning electrodes and signal electrodes are again omitted from the drawing in FIG. 8 for purposes of simplification.

In the fifth embodiment, the liquid crystal display panels B, G and R are held together by a frame 60 at their four edges. In order to connect the scanning electrodes of the liquid crystal display panels B, G and R to a common drive source, the terminals of the scanning electrodes that are arranged such that they oppose each other are electrically connected by the protrusions 61 holding the film substrates 1_{B} and 1_{R} at the ends thereof. Furthermore, the terminals of the scanning electrodes that are arranged such that they oppose each other are electrically connected by the protrusions 62 holding the film substrates 1_{G} and 1_{R} at the opposite ends thereof.

The flexible print circuit 55 extends outside the frame 60 while connected to the terminals of the scanning electrodes at the other end of the film substrate IR, and is connected to a single scanning drive circuit 53 that drives each scanning electrode.

The frame 60 may have an opening through which the flexible print circuit 55 passes. This is also true in the sixth embodiment explained below.

Because the number of flexible print circuits used may be reduced in the fifth embodiment, the fifth embodiment offers the advantage of reduced cost.

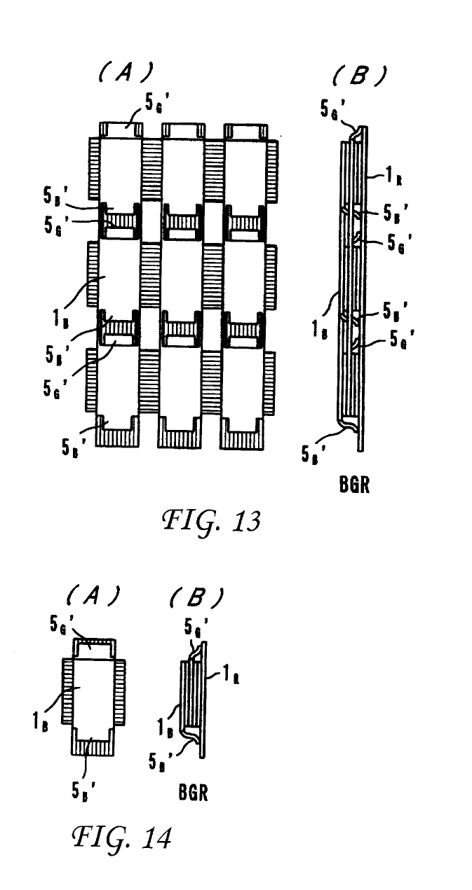

(Sixth Embodiment, See FIG. 9)

The liquid crystal display apparatus of the sixth embodiment is a modification of the fifth embodiment. In other words, in order to connect the scanning electrodes of the liquid crystal display panels B, G and R to a common drive source, the terminals of the scanning electrodes that are arranged such that they oppose each other are electrically connected by inserting the ends of the film substrates 1_{B} and 1_{R} into the frame 60 with the pressing plate 63 pushing into the groove 64. Furthermore, the terminals of the scanning electrodes that are arranged such that they oppose each other are electrically connected by inserting the opposite ends of the film substrates 1_{G} and 1_{R} into the frame 60 with the pressing plate 65 pushing into the groove 66.

The flexible print circuit 55 extends outside the frame 60 while connected to the terminals of the scanning electrodes at the other end of the film substrate 1_{R}, and is connected to a single scanning drive circuit 53 that drives each scanning electrode.

Because the terminals are pressured by the pressing plates 63 and 65 in the sixth embodiment, the electrical connection of the terminals is further ensured.

(Manufacturing Method, See FIGS. 10 Through 14)

One example of the manufacturing process for the liquid crystal display apparatuses comprising the fifth and sixth embodiments will now be explained. The manufacturing example explained below is a method appropriate for simultaneous preparation of multiple multi-layer liquid crystal display apparatuses.

First, nine liquid crystal display panels R, G and B are separately prepared. To specifically explain the manufacturing of the liquid crystal display panel R, as shown in part (A) of FIG. 10, a sheet 10_{R} having a size sufficient to include nine substrates 1_{R} and having pre-formed scanning electrodes for nine substrates 1_{R}, and a sheet 20_{R} that has a size sufficient to include nine substrates 2_{R} and having pre-formed signal electrodes for nine substrates 2_{R}, are made to adhere to each other with a liquid crystal material in between. More precisely, before they are made to adhere to each other, an insulation film and/or an orientation control film are formed on the side of each sheet on which the electrodes are formed where necessary. Spacers are also applied to at least one of the sheets. Furthermore, if necessary, resin bodies are formed on one of the sheets. These processes are also performed in the same manner during the manufacturing of liquid crystal display panels G and B explained below.

The sheet 20_{R} is then divided into multiple sections along the signal electrodes by removing the unnecessary parts thereof. Consequently, as shown in part (B) of FIG. 10, the sheet 20_{R} is divided into multiple sections that are aligned in the direction in which the scanning electrodes extend (the direction of the arrow Y). Moreover, the sheets 10_{R} and 20_{R} are turned over with the sheet 20_{R} in this state, and the unnecessary parts of the sheet 10_{R} are removed in order to divide it into multiple sections along the scanning electrodes. Consequently, as shown in part (C) of FIG. 10, the sheet 10_{R} is divided into multiple sections that are aligned in the direction in which the signal electrodes extend (the direction of the arrow X). The liquid crystal display panel group R from which the sheets 10_{R} and 20_{R} are partially removed in this way is turned over (see part (D) of FIG. 10), and is placed on a support platform such as a stacking plate.

To specifically explain the manufacturing of the liquid crystal display panel G, as shown in part (A) of FIG. 11, a sheet 10_{G} that has a size sufficient to include nine substrates 1_{G} and having pre-formed scanning electrodes for nine substrates 1_{G} and a sheet 20_{G} that has a size sufficient to include nine substrates 2_{G} and having pre-formed signal electrodes for nine substrates 2_{G} are made to adhere to each other with a liquid crystal material in between. The sheet 20_{G} is then divided into multiple sections along the signal electrodes by removing the unnecessary parts thereof Consequently, the sheet 20_{G} is divided into multiple sections that are aligned in the direction in which the scanning electrodes extend (the direction of the arrow Y), as shown in part (B) of FIG. 11.

Furthermore, openings 5_{G} are formed in the areas of the sheet 10_{G} between the divisions of the sheet 20_{G}, i.e., the areas from which the sheet 20_{G} is removed (see part (C) of FIG. 11). The terminals of the scanning electrodes are exposed on these tongues 5_{G}′ of the openings 5_{G}.

The sheets 10_{G} and 20_{G} are then turned over with the sheet 20_{G} in this state, and the sheet 10_{G} is divided into multiple sections along the scanning electrodes by removing the unnecessary parts thereof Consequently, the sheet 10_{G} is divided into multiple sections that are aligned in the direction in which the signal electrodes extend (the direction of the arrow X), as shown in part (D) of FIG. 11. The liquid crystal display panel group G from which the sheets 10_{G} and 20_{G} are partially removed and in which openings are formed is placed over the liquid crystal display panel group R such that the scanning electrodes of the sheet 10_{G} face the liquid crystal display panel group R.

The liquid crystal display panel B is prepared using the process shown in FIG. 12, which is the same process used for the preparation of the liquid crystal display panel group G in principle. In other words, as shown in part (A) of FIG. 12, a sheet 10_{B} having a size sufficient to include nine substrates 1 and having pre-formed scanning electrodes for nine substrates 1_{B}, and a sheet 20_{B} having a size sufficient to include nine substrates 2_{B} and having pre-formed signal electrodes for nine substrate 2_{B} are made to adhere to each other with a liquid crystal material in between. The sheet 20_{B} is then divided into multiple sections along the signal electrodes by removing unnecessary parts thereof Consequently, as shown in (B) of FIG. 12, the sheet 20_{B} is divided into multiple sections that are aligned in the direction in which the scanning electrodes extend (the direction of the arrow Y). Furthermore, openings 5_{B} are formed in the areas of the sheet 10_{B} between the divisions of the sheet 20_{B}, i.e., the areas from which the sheet 20_{B} is removed (see part (C) of FIG. 12). The terminals of the scanning electrodes are exposed on these tongues 5_{B}′ of the openings 5_{B}. The positions at which the openings 5_{B} are formed are opposite from the positions at which the openings 5_{G} are formed, and the tongues 5_{B} protrude in the opposite direction from the direction in which the tongues 5_{G} protrude.

The sheets 10_{B} and 20_{B} are then turned over with the sheet 20_{B} in this state, and the sheet 10_{B} is divided into multiple sections along the scanning electrodes by removing the unnecessary parts thereof. Consequently, the sheet 10_{B} is divided into multiple sections that are aligned in the direction in which the signal electrodes extend (the direction of the arrow X), as shown in part (D) of FIG. 12. The liquid crystal display panel group B from which the sheets 10_{B} and 20_{B} are partially removed and in which openings are formed in this way is placed over the liquid crystal display panel group G such that the scanning electrodes of the sheet 10_{B} face the liquid crystal display panel group G

When placing the panel group G on the panel group R and the panel group B on the panel group Q an adhesive agent, viscous agent or adhesive sheet should be applied between the display panels that are placed together, thereby enabling the display panels to adhere to each other via such agent.

FIG. 13 shows the liquid crystal display panel groups R, G and B prepared in the manner described above when they are stacked together. The tongues 5_{G}′ and 5_{B}′ are in pressure contact with the scanning electrodes of the sheets 10_{R}, so that the scanning electrodes of the liquid crystal panel groups R, G and B are electrically connected.

A multi-layer liquid crystal display element group comprising the liquid crystal display panel groups R, G and B stacked together is manufactured in this way.

Each unit of the liquid crystal display element is then separated from the multi-layer liquid crystal display element group, as shown in FIG. 14, a scanning drive circuit and signal drive circuits are connected thereto, and a liquid crystal display apparatus is thereby completed.

(Other Embodiments)

The display apparatus pertaining to the present invention and the manufacturing method therefor are not limited to the above embodiments, and may be varied within the essential scope of the invention.

In particular, while a liquid crystal display apparatus using cholesteric liquid crystal was used as an example in the above embodiments, the present invention is not limited to this implementation. For example, it may comprise a multi-layer liquid crystal display element comprising multiple display panels stacked together that includes guest-host liquid crystal. In addition, the present invention may be applied in any display apparatus that has multi-layer display panels that are driven via matrix driving, and is not limited to applications in liquid crystal display apparatuses.

The liquid crystal display apparatus may comprise only two display panels stacked together, and in such a case, either the scanning electrodes or signal electrodes of each display panel should oppose each other.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A display apparatus comprising:
a first display panel having a plurality of first scanning electrodes and a plurality of first signal electrodes; and
a second display panel having a plurality of second scanning electrodes and a plurality of second signal electrodes,
wherein the first display panel is stacked on the second display panel such that (i) terminals of the first scanning electrodes oppose to terminal of the second scanning electrodes, and (ii) terminals of the first scanning electrodes are electrically connected to terminals of the second scanning electrodes, respectively.

2. A display apparatus as claimed in claim 1, wherein the terminals of the first scanning electrodes are directly connected to the terminals of the second scanning electrodes, respectively.

3. A display apparatus as claimed in claim 2, further comprising a pressuring member for electrically connecting the terminals of the first scanning electrodes and the second scanning electrodes while in pressure contact with each other.

4. A display apparatus as claimed in claim 1, wherein the terminals of the first scanning electrodes are respectively connected to the terminals of the second scanning electrodes via a conductive material in between.

5. A display apparatus as claimed in claim 4, the conductive material comprising a wiring material having exposed conductive portions for electrically connecting the terminals of the first scanning electrodes and the terminals of the second scanning electrodes, respectively.

6. A display apparatus as claimed in claim 4, further comprising a pressuring member for electrically connecting the terminals of the first scanning electrodes and the second scanning electrodes while in pressure contact with each other.

7. A display apparatus as claimed in claim 1, further comprising a third display panel having a plurality of third scanning electrodes and a plurality of third signal electrodes.

8. A display apparatus as claimed in claim 7, wherein the third display panel is disposed between the first and second display panels.

9. A display apparatus as claimed in claim 8, wherein the third scanning electrodes are electrically connected to the first scanning electrodes, respectively.

10. A display apparatus as claimed in claim 1, wherein the first, second, and third display panels are stacked each other in this order.

11. A display apparatus as claimed in claim 10, wherein the third scanning electrodes are electrically connected to the first scanning electrodes, respectively.

12. A display apparatus as claimed in claim 1, further comprising a scanning electrode drive circuit to which the first scanning electrodes and the second scanning electrodes are commonly connected.

13. A display apparatus as claimed in claim 12, further comprising:
a first signal electrode drive circuit to which the first signal electrodes are connected; and
a second signal electrode drive circuit to which the second signal electrodes are connected.

14. A manufacturing method of a display apparatus comprising the steps of:
(a) stacking multiple display panels, each of which has first and second electrodes, such that terminals of the first electrodes of at least two display panels oppose each other; and
(b) electrically connecting the terminals of the opposing first electrodes after the step (a).

15. A manufacturing method as claimed in claim 14, wherein the step (b) is carried out by placing the terminals in direct pressure contact with each other

16. A manufacturing method as claimed in claim 14, wherein the step (b) is carried out by using a conductive material between the terminals.

17. A manufacturing method of a plurality of display apparatuses comprising the steps of:
(a) forming a plurality of first display panels that are connected each other by carrying out the sub steps of:
(a-1) disposing a first liquid crystal material a first substrate on which a plurality of first scanning electrodes are formed and a second substrate on which a plurality of first signal electrodes, which extend in a different direction from the first scanning electrodes, are formed; and
(a-2) dividing the second substrate into a plurality of sections along the first scanning electrodes,
(b) forming a plurality of second display panels that are connected each other by carrying out the sub steps of:
(b-1) disposing a second liquid crystal material between a third substrate on which a plurality of second scanning electrodes are formed and a fourth substrate on which a plurality of second signal electrodes, which extend in a different direction from the second scanning electrodes, are formed;
(b-2) dividing the second substrate into a plurality of sections along the second scanning electrodes; and
(b-3) forming openings on the third substrate such that tongue-like terminals of the second scanning electrodes are formed;
(c) stacking the second display panels on the first display panels such that the first scanning electrodes oppose to the second scanning electrodes; and
(d) connecting the tongue-like terminals of the second scanning electrodes to the first scanning electrodes.

18. A manufacturing method as claimed in claim 17, further comprising the steps of:
(e) forming a third display panels that are connected each other by carrying out the steps of
(e-1) disposing a third liquid crystal material between a fifth substrate on which a plurality of third scanning electrodes are formed and a sixth substrate on which a plurality of third signal electrodes, which extend in a different direction from the third scanning electrodes, are formed;
(e-2) dividing the sixth substrate into a plurality of sections along the second electrodes;
(e-3) forming openings on the fifth substrate such that tongue-like terminals are formed; and
(f) stacking the third display panels on the second display panels such that the first scanning electrodes and the third scanning first electrodes oppose each other.
